(19) United States
(12) Patent Application Publication
(10) Pub. No.: US 2012/0012538 A1
(43) Pub. Date: Jan. 19, 2012

(54) METHOD OF TREATMENT OF BALLAST WATER

(75) Inventor: James R. PLANT, Victoria (CA)

(73) Assignee: Q5 INNOVATIONS INC., Victoria (CA)

(21) Appl. No.: 13/181,986

(22) Filed: Jul. 13, 2011

Related U.S. Application Data
(60) Provisional application No. 61/363,890, filed on Jul. 13, 2010.

(51) Int. Cl. C02F 1/68

(52) U.S. Cl. 210/764

(57) ABSTRACT

A method of treating ballast water. The method consists of a step of using as a concentrated brine solution having such a high degree of salinity as to kill organisms in the ballast water treatment system. The source of the concentrated brine solution is, preferably, the concentrated hypertonic brine solution produced by a ship's desalination unit.

### FIELD

There is described a method of treatment of ballast water used in shipping.

### BACKGROUND

Historically, as it is today, a vast amount of global trade is conveyed by commercial shipping annually. One profound and negative consequence that this global marine traffic has had is the spread of invasive species that have been inadvertently carried in ballast tank water and ballast tank sediment. As a ship burns its fuel (or off loads its cargo), the displacement of the ship is reduced and can adversely affect the ship's dynamic stability. To compensate for this increased buoyancy, water is taken aboard into ballast tanks to increase the ship's displacement and to distribute the ballast in a manner so as to trim the ship. Often, during this ballasting process, local organisms are taken up with the ballast water into the ballast tank. When the ship is loaded or refueled at its destination port, the ballast water is discharged overboard to maintain a constant displacement. Transport of these invasive species within the ballasting system of ships, from their native marine environment to distant marine environments, has led to the complete collapse of the indigenous species. The ecological and economic impact of invasive species is staggering, and is estimated to cost the U.S. economy $120 billion annually (Kaluza et al, 2010).

Although in recent years there has been a concerted effort to reduce the negative environmental impact of shipping through the adoption of strict international environmental policies regarding combating the transport of invasive species, their successful implementation has been delayed and limited in scope due to both the high cost of many of the proposed treatment systems, as well as the present technical limits to their efficiency.

Strategies for dealing with the potential transport of invasive species in ballast water can be divided in to three broad categories; (a) ballasting protocols and procedures, (b) ballast water treatment, and (c) ballast sea water replacement systems.

International ballasting protocols require that prior to discharging the ballast tanks at the destination port, the ballast system must undergo a deep water exchange whereby at least 95% of the ballast water is exchanged at sea. Although this significantly diminishes the probability of transporting invasive species, there is still a significant possibility that such organisms can remain in the ballast tanks either in the residual water, or contain in sediment in the bottom of the ballast tanks.

In an effort to eradicate all potential invasive species from the ballast water system, numerous methods of treating ballast water have been devised. For treating the inflow of ballast water, the approaches range from filtering the ballast sea water during the process of on loading, hydrodynamic separation of sediment and organisms prior to entering the ballast tank (for example U.S. Pat. No. 7,374,692), to subjecting the ballast water inflow to high-voltage electrolysis (such as with Hamworthy's TERMANOX ballast water treatment units, U.S. Pat. No. 7,241,390, U.S. Pat. No. 7,264,738). In addition, numerous techniques have been proposed to eradicate potential invasive species once the ballast water is in the ballast tank. Proposed and prototype ballast water in-tank treatments have ranged from the introduction of toxic or lethal levels of gases (U.S. Pat. No. 6,869,540, U.S. Pat. No. 7,381,338), chemicals (U.S. Pat. No. 7,476,324, U.S. Pat. No. 7,618,545) or ultraviolet radiation (U.S. Pat. No. 7,025,889, U.S. Pat. No. 7,351,336), to the application of lethal levels of hydrodynamic cavitation or ultrasonic agitation (U.S. Pat. No. 7,585,416, U.S. Pat. No. 7,704,401, U.S. Pat. No. 7,595,003). Many ballast water in-tank treatments (such as chemical, gas, or biological) can pose their own significant environmental and work place hazards, require complex systems and monitoring, thereby limiting their application as potential solutions to the problem of ballast water transported invasive species.

There has also been proposed ballast seawater substitution. That is, forgoing the use of sea water as the primary material for the ballasting of the vessels. The proposed system (U.S. Pat. No. 7,661,378) was complex, required the treatment, storage and monitoring of hazardous materials, and had a variable production rate which potentially limited the availability of the ballasting solution.

### SUMMARY

There is provided a method of treatment of ballast water. The method consists of a step of using a concentrated brine solution having such a high degree of salinity as to kill organisms and injecting the concentrated brine solution into the ballast water treatment system.

The proposed method can readily be implements in all sea going vessels that have a desalination unit. The source of the concentrated brine solution required to follow the teachings of the method can be a concentrated and hypertonic brine solution produced as a byproduct of the operation of the desalination unit. It will be appreciated that the concentrated brine solution can also be produced by a dedicated desalination unit.

Where it is desired to use a sea water replacement, the ballast water can be entirely made up of the concentrated brine solution.

Where it is desired to use sea water that has been treated, the salinity of the sea water can be increased to concentration levels that will kill living organisms by addition of the concentrated brine solution.

Where electrolysis is used to treat sea water, the operation of the electrolysis unit can be made more effective by mixing the sea water with concentrated brine solution.

The concentrated brine solution can also be mixed with sea water to such an extent that it will severely dehydrate, but not kill, living organisms. Upon rehydration, the living organisms will suffer fatal osmotic shock.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1. is a schematic illustration of a method and system for utilizing the concentrated brine solution (preferably generated as a by-product of desalination processing) as a feed and wash water for a ballasting system.

FIG. 2. labelled as PRIOR ART, is a schematic illustration of the prior art highlighting the fact that, at present, there exists no integration of ship-board ballasting and desalination systems.

FIG. 3. is a schematic illustration of a variation of the proposed method and system for utilizing the concentrated brine solution in an electrolysis unit, in this case generated as a by-product of reverse osmosis desalination processing.

### DETAILED DESCRIPTION

The present invention relates to a method for dramatically reducing the potential damaging ecological effects caused by the transport and discharge of ship ballast water containing invasive species by utilizing hypertonic brine solution for ballasting.

Hypertonic brine solution is produced in large volume as a byproduct of the desalination process, and is typically discharged directly over board. In the case of evaporation desalination units, the brine solution is created through the boiling of seawater and the extraction of fresh water through the condensing of the resulting water vapour. As a consequence of this high-temperature processing of the seawater, all organisms which could potentially serve as invasive species are eradicated in the brine water, leaving an ideal ballasting solution. In the case of reverse osmosis desalination processing, (which is carried out at lower temperatures), the hypertonic brine solution should be electrolytically treated to ensure complete eradication of any potential invasive species before being utilized as a ballasting solution. Ballasting with hypertonic brine solution also has the benefit of creating an osmotically hostile environment for any organisms which might be existing in the ballast tank sediment.

The proposed solution takes advantage of the fact that during the operation of shipboard desalination systems, there is the ongoing production of a significant quantity of concentrated brine solution. For example, a midsize cruise ship (such as Holland America's MS Maasdam) will produce approximately 500 tons of fresh water a day, resulting in the production of over 1000 tons of brine solution which is at present discharged overboard. We propose that this abundant source of hypertonic brine solution be redirected and utilized as the primary ballasting material, in addition to supplementing the operational efficiency of electrolysis ballast water treatment systems, if installed, and utilized as a wash solution for flushing the ballasting system.

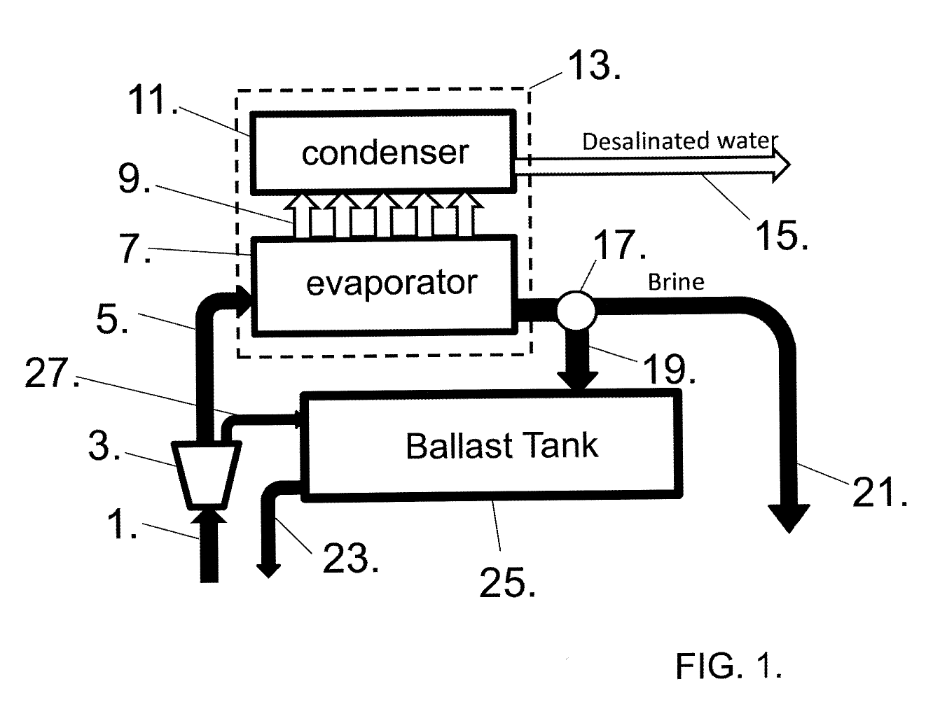

A Method and System for Utilizing Hypertonic Brine Solution for Ballasting, will now be described with reference to FIGS. 1. through 3.

FIG. 1. illustrates how the hypertonic brine solution produced as a byproduct of the operation of an evaporation desalination unit (contained within the dashed box, item 13), can be used as feed and wash water for a ballasting system. The inflow of seawater (item 1.) passes through a filtration unit (item 3.) to create a supply of feed water (item 5.) for the evaporation desalination unit (item 13.). The feed water enters the evaporator (item 7.) where it is heated to produce water vapour (item 9.), and this water vapour enters into a condenser unit (item 11.) where it is condensed and collected to create desalinated water outflow (item 15.). The remaining brine solution then passes through a flow control unit (item 17.), to be directed either into the ballast tank as a ballasting solution (item 19.), or to be discharged over board or utilized in other systems (item 21.). In the case where the available production of brine solution is either (a) not immediately available, or (b) of insufficient supply, a direct inflow of filtered seawater (item 27.) can be temporarily utilized, to later be supplemented to killing salinity levels by brine inflow (item 19.), with excess sea water discharged from the ballast tank (item 23.).

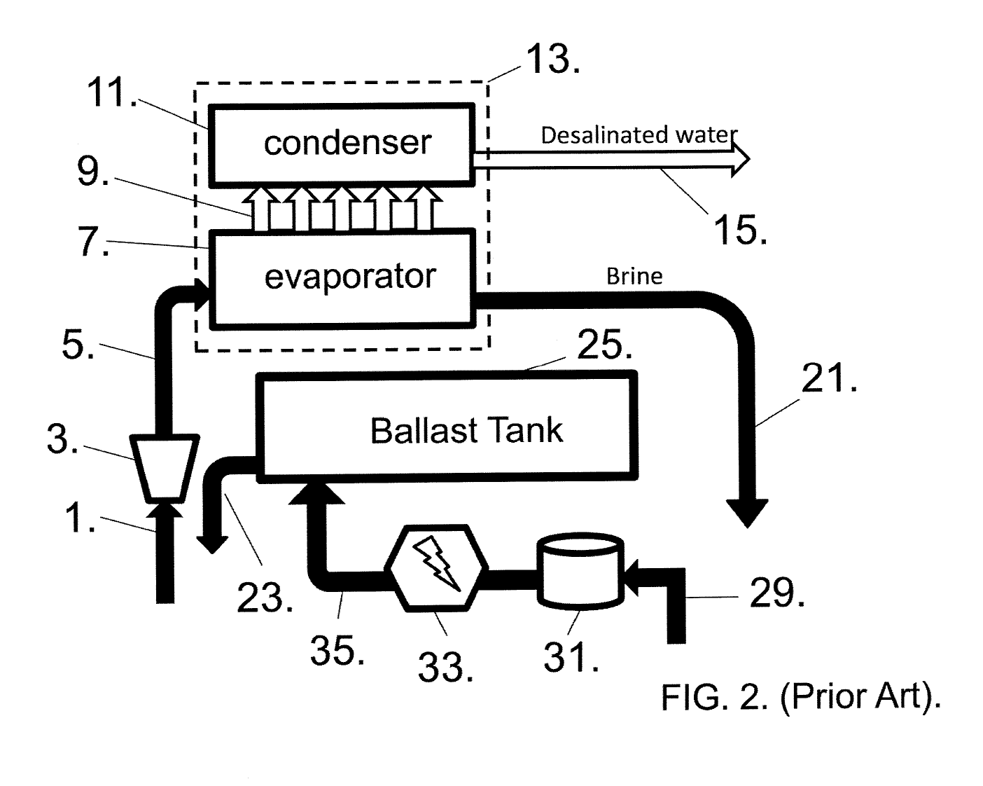

FIG. 2, Prior Art, illustrates how the ballasting and desalination systems typically operate in isolation. As in FIG. 1, filtered seawater is used as feed water (item 5.) to supply the evaporation desalination unit (item 13.). The hypertonic brine byproduct of existing desalination units is directly discharged over board (item 21.). While many ships carry out ballasting with inadequately filtered seawater, we have chose to illustrate one form of ballast water treatment system where the seawater inflow (item 29.) enters a cyclonic filtering system (item 31.) to first remove sediment and marine organisms, and then is passed through an electrolysis unit (item 33.) in an effort to kill any remaining organisms (for example, Hamworthy SEDINATOR (Trademark) and TERMAOX (Trademark) units respectively) before passing through the inflow (item 35.) into the ballast tank (item 25.). The effectiveness of the electrolysis unit (item 33.), and its energy efficiency are critically dependent on the salinity of the seawater. Dilution of the seawater with fresh water (such can happen in harbours with river estuaries, and at a time when ballasting is most likely required) can significantly decrease the electrical conductance of the solution and the efficiency of electrolysis. Under these circumstances, later discharge of the ballast tank (item 23.) can potentially lead to the release of invasive species which were not killed due to the suboptimal operation of the ballast water treatment system under these conditions. Diverting a small portion of the brine outflow (item 21.) to the inflow of the electrolysis unit (item 33.) under these circumstances could significantly enhance the electrolysis process and significantly decrease the current required through increasing the ballast inflow's electrical conductance (not illustrated).

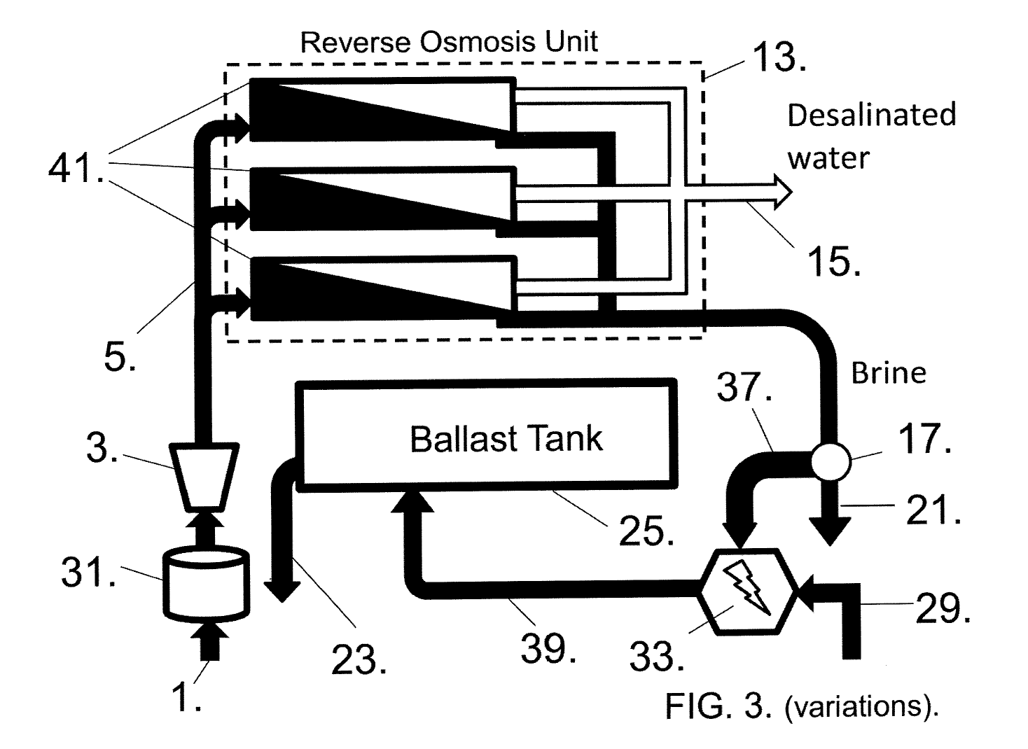

FIG. 3., Variations, illustrates the integration of a reverse osmosis desalination unit with a ballasting system. In this embodiment, the seawater inflow (item 1.) passes through a SEDINATOR (Trademark) cyclonic filtering unit (item 31.), a further filtering step (item 3.), to create feed water input (item 5.) for the reverse osmosis desalination unit (item 13.). Unlike in evaporation desalination units, the feed water is not heated to produce water vapour. Instead, the feed water (item 5.) enters into a number of pressure vessels (collectively labeled item 41.) which contain membranes which are selectively permeable to water molecules. As a result, desalinated water collects on one side of the membrane and it is collected from the numerous pressure vessels to form a fresh water outflow (item 15.). A concentrated brine solution is trapped on the other side of the membrane, where it is subsequently collected from the numerous pressure vessels to create a brine outflow which passes through a flow control unit (item 17.). Due to the relatively low processing temperatures, the brine output may still contain living organisms which could potentially represent an invasive species if the brine output is substantially diluted by sea water and later discharged from the ballast tank. As a result, the brine solution diverted to be used for ballasting (item 37.) first passes through an electrolysis system (item 33.) and is directed (item 39.) into the ballast tank (item 25.) for ballasting. Excess brine solution is either discharged over board or utilized by other systems (item 21.). In the cases where the brine solution is (a) not immediately available, or (b) of insufficient supply, a direct uptake of filtered seawater can be utilized (item 29.) as input to the electrolysis system for ballasting, and discharged (item 23.) as adequate brine solution becomes available.

### Variations:

Reverse osmosis systems produce concentrated brine solution which has not been brought to a boiling temperature as in evaporation desalination units. As a result, organism contained in the feed water may survive the desalination process. Although it is unlikely that organisms adapted to seawater could survive the osmotic stresses induced by submersion in the concentrated brine solution for any extended period of time, it is still advisable that the brine solution be processed prior to use as a ballasting solution (see FIG. 3.). Utilizing an electrolysis system (such as Hamworthy's TERMANOX (Trademark) unit) would be most efficient since (a) the unit's effectiveness is based on salt concentrations of the fluid, and (b) the higher conductivity of the brine solution should significantly lower the current required for effective operation of the unit.

In addition to being utilized as a source for ballasting a ship, the hypertonic brine solution may be used as a feed source for washing out the ballasting system. For maximum osmotic shock, the ballast tank would be first washed out with the hypertonic brine solution, followed by rinsing the tank with fresh water. In addition, the fresh water could be mixed with ozone to maximize trans-membrane transport of this toxic substance during rehydration of the organisms.

### Cautionary Warnings:

It should be stated that the hypertonic brine solution has physical properties significantly different from typical sea water; that of having a higher concentration of salts per volume, and of having a significantly higher density. It is therefore important to be aware of two potential issues; (a) the corrosive effects of such a solution, and (b) that adequate ballast tank structural reinforcement and internal baffling is in place to compensate for any effects of movement and sloshing that this higher density solution may have on structural integrity of the ballast tanks themselves, or on the dynamic stability of the ship.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A method of treatment of ballast water, comprising:
using a concentrated brine solution having such a high degree of salinity as to kill organisms to enhance ballast water treatment.

2. The method of claim 1, wherein all of the ballast water is the concentrated brine solution.

3. The method of claim 1, wherein the concentrated brine solution is mixed with sea water to raise salinity of the sea water, until the mixed sea water-concentrated brine solution has such a high degree of salinity as to kill all organisms in the ballast water.

4. The method of claim 1, wherein the concentrated brine solution is produced as a byproduct of operation of a desalination unit.

5. The method of claim 1, wherein the concentrated brine solution is mixed with sea water to raise salinity of the sea water in preparation for treatment in an electrolysis unit, the operation of the electrolysis unit being made more effective by increasing the salinity of the sea water with the concentrated brine solution.

6. The method of claim 1, wherein the concentrated brine solution is used to dehydrate organisms in the sea water, the organisms experiencing osmotic shock when rehydrated.

7. The method of claim 1, wherein the concentrated brine solution is used for flushing ballast tanks.

8. The method of claim 7, wherein a sequential flushing of the ballast tanks is performed, a first flushing being with the concentrated brine solution followed by a second flushing with fresh water to induce osmotic shock.

9. The method of claim 8, wherein the fresh water is treated with ozone as a supplement to the osmotic shock.
